(19) United States
(12) Patent Application Publication
(10) Pub. No.: US 2025/0194852 A1
(43) Pub. Date: Jun. 19, 2025

(54) AUTOMATIC ROTATING SKEWER DEVICE

(71) Applicants: Chris Tucker, Stansbury Park, UT (US); Katie Tucker, Stansbury Park, UT (US)

(72) Inventors: Chris Tucker, Stansbury Park, UT (US); Katie Tucker, Stansbury Park, UT (US)

(21) Appl. No.: 18/983,435

(22) Filed: Dec. 17, 2024

Related U.S. Application Data
(60) Provisional application No. 63/611,236, filed on Dec. 18, 2023.

(51) Int. Cl. A47J 37/04

(52) U.S. Cl. CPC A47J 37/041

(57) ABSTRACT

An automatic rotating skewer system, comprising a housing with a front cap and an end cap, enclosing a battery, a printed circuit board, and a motor. The system includes a skewer with a prong end and a second end, which resides within the housing when the front cap is fixed. The motor, controlled by the printed circuit board, transfers rotational motion to the skewer via a socket. The skewer and socket may have corresponding flat sections for engagement, and the housing body may be coupled by fasteners. The motor shaft and socket may have corresponding flat areas for rotation. The skewer may have a first groove and the front cap may include a bushing that resides within this groove. The skewer may also have a seal groove with a skewer seal residing within it. The skewer's prong end may comprise two prongs that double back along the skewer axis.

### CROSS REFERENCE TO RELATED APPLICATIONS

This application claims benefit from currently pending U.S. Provisional Application No. 63/611,236 titled “Automatic Rotating Skewer Device” and having a filing date of Dec. 18, 2023, all of which is incorporated by reference herein.

### FIELD OF THE INVENTION

This invention relates to cooking apparatus, and more specifically to a cooking device such as an automatic rotating skewer device that is designed to improve the efficiency and convenience of grilling or roasting food items on an open flame such as a campfire.

### BACKGROUND OF THE INVENTION

Cooking skewers have long been employed in the culinary arts for preparing a variety of dishes, particularly those involving grilling or roasting of meats, vegetables, and other food items. Conventional skewers typically consist of a straight or curved metal rod onto which food items are threaded for even cooking over an open flame or heat source. Traditional skewer systems require manual rotation to ensure even cooking of the food items. This manual process can be time-consuming and inconvenient, especially when cooking a large quantity of food. Furthermore, the manual rotation may not always result in even cooking due to inconsistent rotation speed and frequency.

Automatic rotating skewer systems have been developed to address these issues. However, these systems often have complex designs and require a direct power source, limiting their portability and ease of use. These systems may not provide a secure and stable connection between the skewer and the rotation mechanism, leading to slippage and uneven cooking. Additionally, current automatic skewer systems are only indoor use and require the user to have a spit with an electrical source to power the automatic skewer.

Therefore, there is a need for an automatic rotating skewer system that is simple in design, portable, and provides a secure and stable connection between the skewer and the rotation mechanism. The present invention represents a significant improvement over the prior art by providing a simple, portable, and efficient automatic rotating skewer system that ensures even cooking of food items.

### BRIEF SUMMARY OF THE INVENTION

The present invention is an automatic rotating skewer system, comprising a housing with a front end and a back end. The system can have a skewer with a prong end and a second end, wherein the front end of the housing can be configured to allow the second end of the skewer to reside within the housing. At least one battery and a printed circuit board can be coupled to the battery that controls a motor. A socket can be coupled to the motor which can be configured to accommodate the second end of the skewer and transfer rotational motion from the motor to the skewer.

The automatic rotating skewer system can further comprise a first bearing coupled to the front end of the housing and a second bearing within the housing body. The housing can have removable front or end caps. The battery can be rechargeable, and the socket can be removably coupled to the skewer. The skewer can have a flat section, and the socket can have a corresponding flat section that engages the skewer flat section when the skewer is accommodated within the socket. A printed circuit board can be coupled to a push button switch.

The front end of the housing can further comprise a first seal and the end cap can comprise a second seal. The first bearing and the second bearing may create a seal around the skewer when the skewer is accommodated within the socket. The skewer can have a first groove, and the front end of the housing may further comprise a bushing that resides within the first groove. The system can have a socket with an axial support. The front end of the housing may further comprise a skewer seal. The skewer may have a seal groove, and the skewer seal may reside within the seal groove. The housing body may have a right side and a left side, and the right side may be coupled to the left side by at least one fastener. The first bearing can be held into the front end of the housing by a bushing.

The automatic rotating skewer system can have a motor with a motor shaft having a motor shaft flat area and the socket may have a corresponding socket motor flat area contacting the motor shaft flat area that allows rotation of the motor shaft to rotate the socket. At least one of the first seal and the second seal may be a gasket or an O-ring. The skewer can have a skewer axis, and the prong end may comprise two prongs that double back along the skewer axis.

It is an object of the invention to provide users while camping or roasting food over a campfire or open flame a way to rotate the food, so it cooks evenly.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims. Aspects and applications of the invention presented here are described below in the drawings and detailed description of the invention.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of . . . ”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts an isometric view of automatic skewer system in accordance to one or more embodiments;

FIG. 2 depicts a front view of automatic skewer system in accordance to one or more embodiments;

FIG. 3 depicts a top view of automatic skewer system in accordance to one or more embodiments;

FIG. 4a depicts a side view of an automatic skewer system in accordance to one or more embodiments; and

FIG. 4b depicts a cross-section view of FIG. 4a of a top view of automatic skewer system in accordance to one or more embodiments.

FIG. 4c depicts an exploded view of FIG. 4b of an automatic skewer system in accordance to one or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

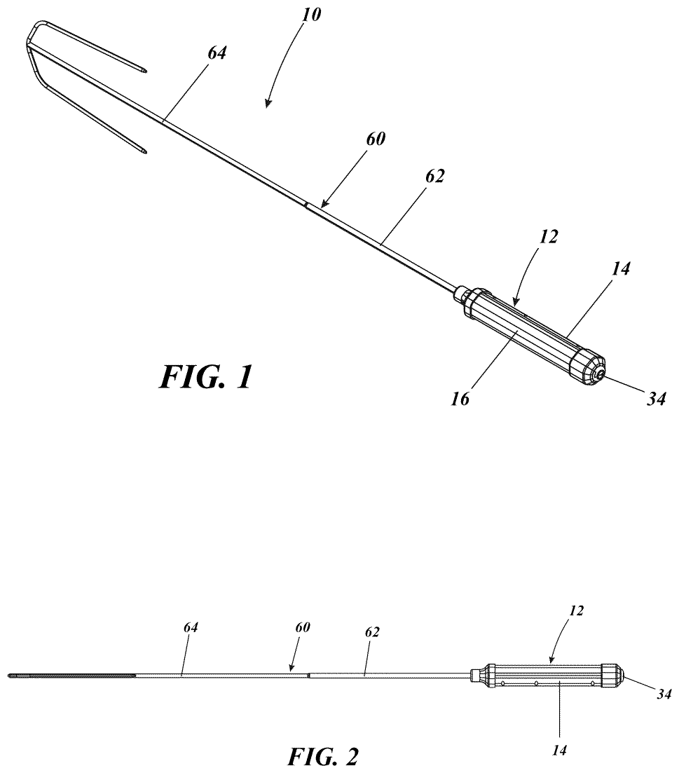

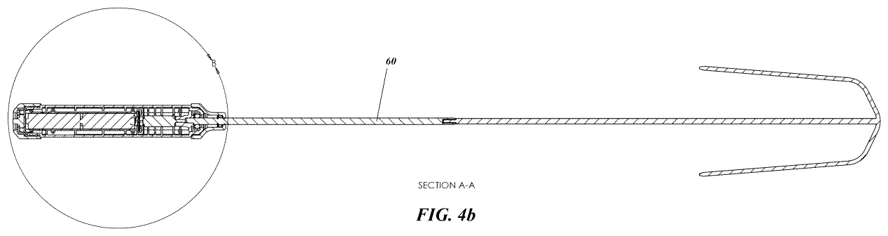

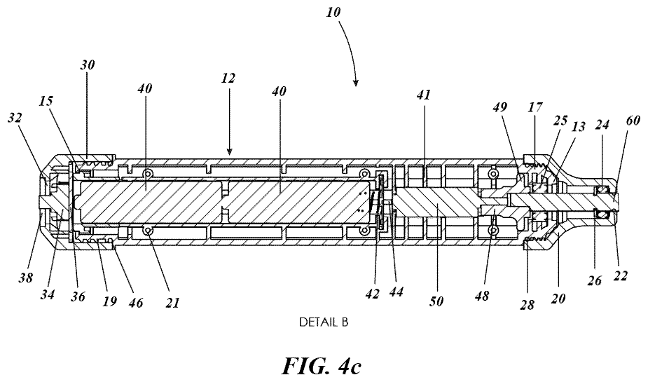

Referring initially to FIGS. 1-4c an automatic rotating skewer system is shown generally at 10. The automatic rotating skewer system 10 can comprise a housing 12 having a housing body with a front end 13 having a front cap 20 and a back end 15 having an end cap 30. The housing 12 can have at least one battery 40 which can be coupled to a spring 42 and printed circuit board 36 (“PCB”) that is coupled to and controls a motor 50. The housing 12 can have a right side 14 and a left side 16 which can form the housing body wherein each side can have a front end 13 and a back end 15 such that the right side 14 can be removably or permanently coupled to the left side 16 by at least one fastener 21. The housing 12 can be manufactured from such as, for example, plastic, metal, ceramic, composite, or the like. The housing 12 can be made of one piece or more than one piece such as the current embodiment which is made from two parts. The housing 12 front end 13 can have front threads 17 and the back end 15 can have back threads 19 wherein the front threads and the back thread can be male threads or in certain embodiments female threads.

The system can further comprise a skewer 60 can have a prong end 66 and a second end 67, wherein the front cap 20 can be configured to allow the second end to reside within the housing 12 when the front cap is fixed to the housing. A motor 50 can be coupled to a contact 44 on one end and a socket 48 on the other end wherein the socket can be configured to accommodate the second end 67 of the skewer 60 and transfer motion from the motor to the skewer. The motor 50 can be such as, for example, DC motor, AC motor, stepper motor, linear motor, brushless motor, or the like. The motor 50 can be coupled to the contact 44 and a spring 42 wherein the at least one battery 40 can power the motor. The motor 50 can rotate at one speed or in other embodiments the motor can allow the user to choose the rotational speed of the skewer 66 or can have multiple preset rotational speeds for different types of foods that are placed on the skewer. The PCB can be coupled to the housing and/or end cap 30.

In embodiments, the socket 48 can be removably coupled to the skewer 60 wherein the skewer can have more than one section which can be a first skewer section 62, and a second skewer section 64 wherein the first skewer section has the second end 67 and the second skewer section has the prong end 66 or in other embodiments the skewer can be one piece or more than two pieces. The first skewer section 62 can have a skewer seal 22 which can be coupled to the first skewer section 62 wherein when the first skewer section can be inserted into a front cap 20 the skewer seal can create a seal between the front cap and the first skewer section keeping containaments such as, dirt, liquids, or the like from entering the front cap 20. The second end 67 can have a skewer flat section 68 and wherein the socket has a corresponding socket flat section 56 that can engage the skewer flat section when the skewer is accommodated within the socket. The skewer 60 can have a skewer axis and the prong end 66 can comprise two prongs that double back along the skewer axis and in other embodiment the skewer can have at least one prong.

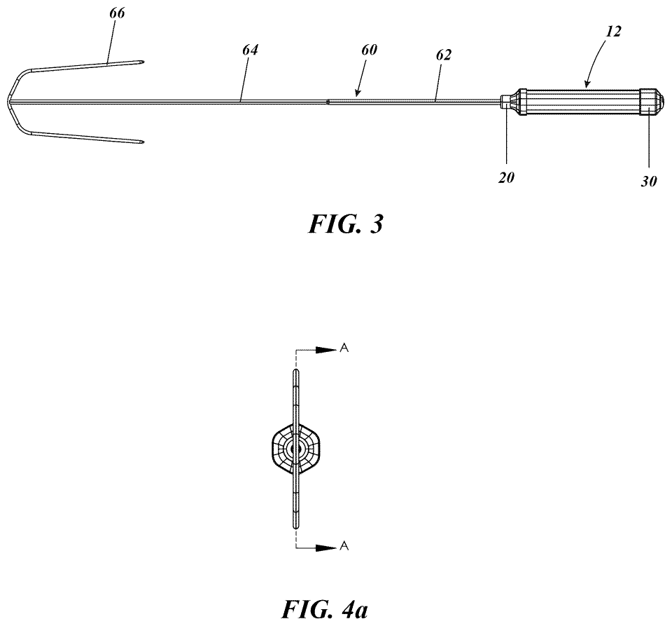

In embodiments, the front cap 20 can be removably coupled to the front end 13 and the end cap 30 can be removably coupled to the back end 15. The front cap 20 and the end cap 30 can be removably coupled to the front end 13 and the back end 15 by such as, for example, threads, adhesive, fastener, rivets, adhesive, snaps or the like. The front cap 20 can further comprise a first bearing 24 which can be coupled to the front cap by a first bushing 26, or in other embodiments by such as, for example, press fit, set screw, rivets, adhesive, snaps, or the like. The front cap 20 can be any suitable size or shape, but in the preferred embodiment the shape is as shown in FIG. 2. The front cap 20 can be manufactured from such as, for example, plastic, metal, ceramic, composite, or the like. The front cap 20 can further comprise a first seal 28 and the end cap 30 comprises a second seal 46 wherein at least one of the first seal and the second seal is such as, for example, a gasket, O-ring, or the like. The first seal 28 can be placed between the front cap 20 and the housing 12 front threads 17 creating a seal between the front cap and the housing.

In embodiments, the socket 48 can have a front socket end 52 having a socket front flat area 56 wherein the skewer 60 second end 67 can have an opposing skewer flat section 68 to keep the skewer from slipping within the front socket end. The socket 48 can have an axial support 49 and a socket back end 54 having a back flat area wherein the axial support can substantially come into contact with the housing's inner diameter while still allowing the socket to spin freely. The socket 48 can rotate within the housing 12 wherein the front end 13 can have a first bearing 24 coupled to it wherein the first skewer section 62 can be inserted into the first bearing. The first bearing 24 and the second bearing 25 can support the first skewer section 62 allowing the skewer 60 to rotate easily as the motor 50 turns and the first bearing and the second bearing can create a seal around the skewer when the skewer is accommodated withing the socket. The first bearing 24 and the second bearing 25 can be such as, for example, ball bearings, roller bearings, linear bearings, miniature bearings, or the like. The first bearing 24 can be supported within the front cap 20 and can provide axial support to the skewer 60.

The motor 50 can have a motor shaft 70 having a motor shaft flat area that can be coupled to the socket 48 wherein the socket can have an opposing flat area or in other embodiments the socket can have a set screw that can be tightened down onto the motor's shaft or the motor shaft and socket can be polygonal, rectangular or the like in shape which can allow the motor to turn the socket. The motor 50 can be removably coupled to the PCB 36 on the end cap 30 side wherein the PCB can complete the circuit between the at least one battery 40, the motor, the spring 42 and the contact 44. The PCB 36 can be such as, for example, single layer, double layer, rigid, flexible or the like and in certain embodiments can have a micro-controller (“MCU”) and motor driver attached to it which can allow the user to control the rotational speed and time of the automatic rotating skewer system 10 by a wireless module and a portable computing device wherein the portable computing device or MCU can allow the user to set desired cook times and alert the user when the food is done.

In certain embodiments, the housing 12 can have a display or the display can be on a portable computing device which can display to the user, such as, for example, cook time, temperature of the food, type of food, number of rotations or the like. The temperature of the food being cooked can be displayed on the display by having at least one sensor that can be located in the housing 12 and/or the second skewer section 64. The skewer 60 can have a temperature sensor coupled to it or can have infrared sensor in the housing which can detect the foods temperature and/or the cooking source's temperature. The portable computing device can alert the user when the temperature of the food is at the desired temperature.

In embodiments, the end cap 30 can further comprise a charging port 32, a switch 34 which can be coupled to the back cover 38 wherein the switch and charging port can be coupled to and protected by the back cover. In certain embodiments, the back cover 38 or charging port 32 can be omitted. In embodiments, the switch 34 can be such as, for example, push button switch, rotary switch, rocker switch, limit switch, soft switch, or the like. The charging port 32 can be such as, for example, USB, USB-C, mini-USB, or the like. The back cover 38 can be made of flexible material allowing the user to push the switch 34 or charge the batteries through the charging port 32. The end cap 30 can be removable allowing the user to access the at least one battery 40 allowing the user to change the battery.

The housing 12 can include one or more supports 41 strategically positioned throughout its interior to securely hold the internal components in place. These supports can stabilize and anchor key elements such as the at least one battery 40, the contact 44, the motor 50, the socket 48, and the second bearing 25, ensuring their proper alignment and functionality during operation. In certain embodiments, the supports 41 can be an integral part of the housing 12, molded directly into its structure during manufacturing. This integrated design can enhance structural integrity, reduce assembly complexity, and minimize component movement or vibration. Alternatively, the supports 41 may be separate elements that are attached to the housing, offering flexibility in customization and the ability to adjust or replace specific supports to accommodate various component configurations. The supports not only provide mechanical stability but also help to protect the internal components from shocks, vibrations, and external forces, thereby increasing the durability and longevity of the device. Additionally, the supports can be designed with precision to facilitate easy assembly and disassembly of the components, enabling efficient maintenance or replacement when required.

The automatic rotating skewer system 10 can deliver a user-friendly and efficient solution for rotating skewers during cooking, enhancing both convenience and cooking precision. The system 10 can be simple to operate and maintain, making it accessible for users of all experience levels. Its rechargeable battery provides extended operational periods, ensuring the system is ready for use in various cooking scenarios without frequent recharging. To maintain safety and hygiene, the system can incorporates seals on critical components, including the front cap 20, end cap 30, and skewer 60. These seals effectively prevent the ingress of unwanted contaminants such as grease, dirt, or debris, ensuring safe operation into the housing 12.

The switch 34 offers seamless control over the system's functions, allowing users to activate or deactivate the rotation effortlessly. The inclusion of a charging port enhances convenience by providing a straightforward method to recharge the battery 40, ensuring that the system remains functional and ready for use with minimal downtime. The system 10 features a robust housing 12 that safeguards the internal components from damage caused by impacts, moisture, or high temperatures. Additionally, the socket 48 and skewer 60 are engineered to prevent slippage during operation, ensuring that the skewer remains securely in place. This feature promotes a consistent and reliable cooking experience, allowing food to cook evenly and thoroughly. Overall, the automatic rotating skewer system 10 can combine functionality, durability, and ease of use to meet the demands of modern cooking.

While the invention has been described in detail and with reference to specific embodiments thereof, it will be apparent to one skilled in the art that various changes and modifications can be made therein without departing from the spirit and scope thereof.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

We claim:

1. An automatic rotating skewer system, comprising:
a housing having a housing body with a front end having a front cap and a back end having an end cap;
a skewer having a prong end and a second end, wherein the front cap is configured to allow the second end to reside within the housing when the front cap is fixed to the housing;
wherein the housing encloses:
at least one battery
a printed circuit board coupled to the battery that is coupled to and controls a motor;
a socket coupled to the motor configured to accommodate the second end of the skewer and transfer rotational motion from the motor to the skewer.

2. The automatic rotating skewer system of claim 1, further comprising a first bearing coupled to the front cap and a second bearing within the housing body.

3. The automatic rotating skewer system of claim 1, wherein at least one of the front cap and the end cap is removable.

4. The automatic rotating skewer system of claim 1, wherein the battery is rechargeable.

5. The automatic rotating skewer system of claim 1, wherein the socket is removably coupled to the skewer.

6. The automatic rotating skewer system of claim 5, wherein the second end has a skewer flat section and wherein the socket has a corresponding socket flat section that engages the skewer flat section when the skewer is accommodated within the socket.

7. The automatic rotating skewer system of claim 1, wherein the printed circuit board is coupled to a push button switch.

8. The automatic rotating skewer system of claim 1, wherein the front cap further comprises a first seal and the end cap comprises a second seal.

9. The automatic rotating skewer system of claim 2, wherein the first bearing and the second bearing create a seal around the skewer when the skewer is accommodated withing the socket.

10. The automatic rotating skewer system of claim 1, wherein the skewer has a first groove and wherein the front cap further comprises a bushing that resides within the first groove.

11. The automatic rotating skewer system of claim 1, wherein the socket has an axial support.

12. The automatic rotating skewer system of claim 1, wherein the front cap further comprises a skewer seal.

13. The automatic rotating skewer system of claim 12, wherein the skewer has a seal groove and wherein the skewer seal resides within the seal groove.

14. The automatic rotating skewer system of claim 1, wherein the housing body has a right side and a left side and wherein the right side is coupled to the left side by at least one fastener.

15. The automatic rotating skewer system of claim 1, wherein the first bearing is held into the front cap by a bushing.

16. The automatic rotating skewer system of claim 1, wherein the motor has a motor shaft having a motor shaft flat area and wherein the socket has a corresponding socket motor flat area contacting the motor shaft flat area that allows rotation of the motor shaft to rotate the socket.

17. The automatic rotating skewer system of claim 8 wherein at least one of the first seal and the second seal is a gasket or an O-ring.

18. The automatic rotating skewer system of claim 1 wherein the skewer has a skewer axis and wherein the prong end comprises two prongs that double back along the skewer axis.
